(19) United States
(12) Patent Application Publication
(10) Pub. No.: US 2025/0072445 A1
(43) Pub. Date: Mar. 6, 2025

(54) COMPOSITIONS COMPRISING FREEZE-DRIED COMPONENTS AND METHODS OF MAKING AND USING SAME

(71) Applicant: Holsem Brands, LLC, San Diego, CA (US)

(72) Inventors: Muna Farhat, San Diego, CA (US); Salpi Sleiman, San Diego, CA (US)

(21) Appl. No.: 18/688,339

(22) PCT Filed: Sep. 1, 2022
(86) PCT No.: PCT/US2022/042392

§ 371 Date: Feb. 29, 2024

Related U.S. Application Data
(60) Provisional application No. 63/239,840, filed on Sep. 1, 2021.

(51) Int. Cl. A23F 5/14; A23L 2/39; A23L 19/00

(52) U.S. Cl. CPC A23F 5/14; A23L 2/39; A23L 19/01

(57) ABSTRACT

A dry mix composition comprising roasted coffee beans prepared as ground or freeze-dried, at least one of a freeze-dried fruit component and a freeze-dried vegetable component and an effective amount of at least one neutralizer. Also a novel production or processing method of roasting coffee with a dry mix composition comprising a least one member selected from the group consisting of a freeze-dried fruit component and a freeze-dried vegetable component wherein the process corrects for various levels of acidity in coffee, fruits and vegetables together with a milk product in a manner that corrects pH and solves the curdling problems prevalent in the art.

### RELATED APPLICATIONS

This application is the National Stage entry of International Application No. PCT/US2022/042392, filed Sep. 1, 2022, which claims the benefit of and priority to U.S. Provisional Patent Application No. 63/239,840, filed Sep. 1, 2021, the entire contents of which are hereby incorporated by reference in their entireties for all purposes.

### FIELD OF THE INVENTION

The present invention relates to novel coffee compositions comprising roast and ground coffee and certain fruit presented in freeze-dried form, combined with a milk component, as well as novel production/manufacturing processes related thereto.

### BACKGROUND OF THE INVENTION

Coffee has been consumed across the world for centuries, with certain cultures having established brewing methods seeped in ancient traditions. Depending on the geographic region, some cultures prefer very strong coffee as a hot drink, while other people prefer cold, strong brews of the coffee bean. Indeed, some regions (particularly throughout southeast Asia) prepare coffee by brewing specific mixtures of roasted and ground coffee, together with further ingredients including corn, beans, peas and rice.

While coffee and coffee mixtures have been known for many years, all such combinations must be tailored to accommodate similar issues in the final product. Coffee is, by nature, very acidic in its final brewed form with water. When drinking coffee in plain form (ie. nothing other than ground coffee beans brewed with hot water), it is highly acidic. Adding other, more basic pH elements, such as milk, reduces the acidity. However, the more elements one adds to coffee and milk, the more one risks negatively affecting taste, pH balance, etc.

The prior art contains certain examples of combining other compositions within coffee to form a coffee mix meant for brewing into a final, drinkable cup of coffee.

International Patent Publication No. WO2021005429A1 to Maneesh discloses a dry mix composition comprising roast and ground coffee, together with certain freeze-dried fruits, resulting in a nutritional cup of coffee due to the freeze-dried fruit component. However, such a composition will suffer from pH (highly acidic due to both coffee and fruits) and taste (certain fruits must be balanced out due to vitamin content) problems absent any other acid remediation techniques, which the disclosure fails to mention.

Canadian Patent No. 3,010,363 to Gil et al. discloses a similar type of mixture, with freeze dried fruits native to South America. While freeze-drying may preserve the nutrient qualities of the fruit component, many of the vitamins, carotenoids and polyphenols may degrade once brewed with boiling water. Additionally, there is still the problem of balancing the acidity profile of such a mixture, as well as providing a good taste and maintaining a consistent flavor profile in the final, brewed coffee product.

Alternative coffee mixtures on the market use oils or essences, which use artificial or natural flavors, thereby diminishing the natural benefit derived from real fruit or vegetables. Freeze-dried fruit compositions are in the market today, but are limited to create smoothies or “superfood lattes.” However, such “lattes” do not include coffee and, if such a smoothie composition is indeed mixed with real milk, the final product would curdle, resulting in an unsatisfactory taste and unhealthy final product.

There remains a need in the art for being able to combine coffee with freeze-dried fruits and/or vegetables, along with milk, to both maintain a good taste and avoid the curdling of the milk in the final product.

### SUMMARY OF THE INVENTION

The present invention provides a dry mix composition comprising roasted coffee beans prepared as ground or freeze-dried, at least one of a freeze-dried fruit component and a freeze-dried vegetable component and an effective amount of at least one neutralizer selected from the group consisting of malt, sodium bicarbonate, oats and corn starch. Optionally, the at least one freeze-dried fruit component is added together with the at least one freeze-dried vegetable component. Preferably, a milk component is added to the composition. Alternatively, the dry mix composition comprises the freeze-dried fruit composition without the freeze-dried vegetable composition. In an alternative embodiment, the dry mix composition comprises the freeze-dried vegetable composition without the at freeze-dried fruit composition.

In another aspect, the present invention discloses a method of brewing coffee with a dry mix composition comprising a least one member selected from the group consisting of a freeze-dried fruit component and a freeze-dried vegetable component, the method comprising:
(a) selecting initial ingredients based on optimal pH;
(b) roasting an amount of coffee beans to the optimal pH;
(c) grinding the amount of coffee beans to the optimal pH;
(d) brewing an amount of coffee from the amount of coffee beans to create a brewed coffee;
(e) mixing the dry mix composition together with the brewed coffee; and
(f) adding at least one neutralizer component.

Optionally, a milk component is added in the method of brewing coffee with the dry mix composition.

In yet another embodiment, the present invention provides for a method of formulating a freeze-dried coffee and fruit composition, comprising: (1) providing a plurality of fruits and vegetables; (2) freeze-drying the plurality of fruits and vegetables; (3) grinding the freeze-dried product of (2) into a fine powder; (4) providing coffee beans selected based on a desired pH; (5) roasting the coffee beans to the desired pH; (6) grinding the roasted coffee beans; (7) freeze-drying the ground, roasted coffee beans; (8) combining the freeze-dried coffee beans together with the freeze-dried powder of the fruits and vegetables by blending them both in a mixer to form a blended formulation; (9) measuring the pH of the blended formulation and (10) adding a neutralizer to the blended formulation in order to maintain the desired pH.

### BRIEF DESCRIPTION OF THE DRAWINGS

The novel features of the present invention are set forth herein embodied in the form of the claims of the invention. Features and advantages of the present invention may be best understood by reference to the following detailed description of the invention, setting forth illustrative embodiments and preferred features of the invention, as well as the accompanying drawings, of which:

FIG. 1 shows a preferred embodiment of method of manufacturing the compositions described in the present invention.

FIG. 2A-2C shows an example of a Roast Profile prepared according to the present invention.

FIG. 3A-3C shows an example of a Roast Profile prepared according to the present invention.

### DETAILED DESCRIPTION OF THE INVENTION

The combination of varying levels of acidity in any type of fruit or vegetable must be taken into consideration when developing such components into a final mixture for human consumption. Specifically, when the acid in fruits or vegetables are combined with the acid levels present in brewed coffee, such acidity impacts the fats, proteins and lactic acid assemblies in milk, which creates a curdling effect and is something that is to be avoided at all costs. The problem is compounded even more in various types of coffee drinks, such as lattes.

The present invention provides for a novel process that avoids such detrimental impacts on combinations of fruits and vegetables within a brewed coffee product, yielding a drinkable final product that accommodates the varying pH levels in order to create a flavored line of standard coffee or latte beverages. The present invention produces a final composition which combines various levels of acidity in coffee, fruits and vegetables together with a milk product in a manner that corrects pH and solves the curdling problems so prevalent in the art.

In one aspect, the present invention provides for an acid neutralizing process comprising a neutralizing component that is added to the coffee/fruit/vegetable composition in order to alleviate the problems associated with milk is combined with heat. The neutralizing component is at least one component selected from the group consisting of malt barley, malted milk, sodium bicarbonate, oat milk powder, coconut milk powder, Dutch process cocoa and medium chain triglyceride (MCT) oil. In an alternative embodiment, the neutralizing component is a component that provides a basic pH level to counteract or balance the acidic pH level in the coffee/fruit/vegetable composition during the brewing process.

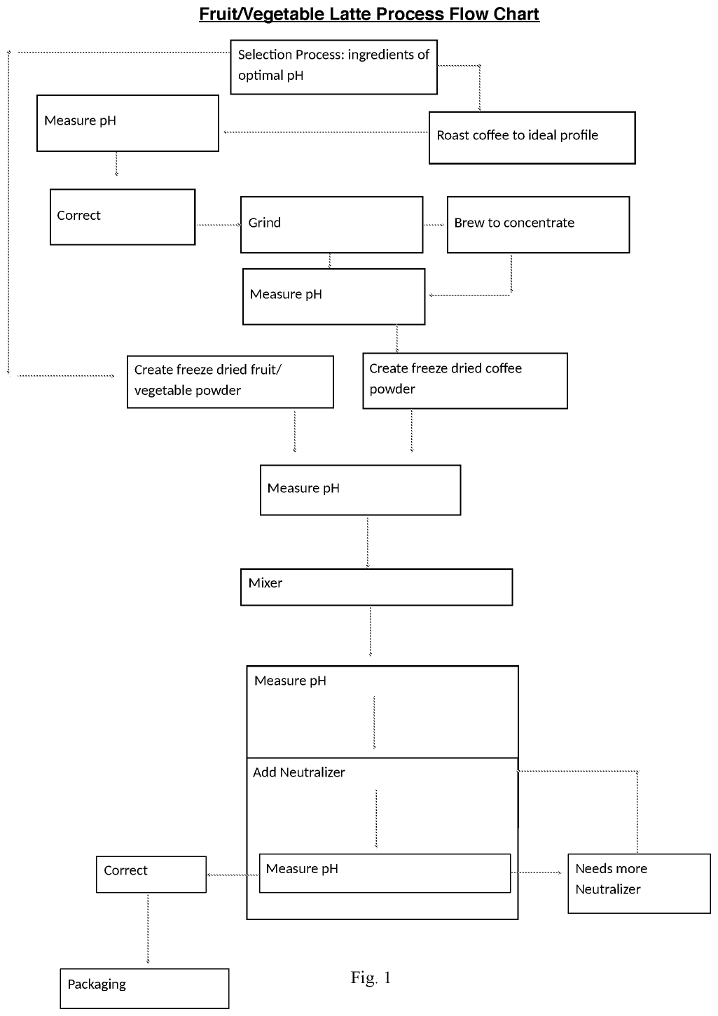

As shown in FIG. 1, the novel process disclosed in the present invention requires specific steps in the brewing process in order to arrive at a final product that balances diverse acidity levels and avoids the problems of curdling milk when heat is added. Preferably, the grinding and brewing of the coffee is adjusted prior to making the freeze-dried components in a manner that has a positive effect on pH.

Acidity levels are impacted through any roasting step in the coffee brewing process. The beans' natural character influences the acidity, even at the initial stages of the processing. It is known in the art that pH levels of coffee can range from 4.85 to 5.10, depending on the specific elements of the brewing process. Coffee that is acidic could relate to the drink having a “sour” flavor due to a lower or higher extraction step during the brewing process. Certain coffees do have natural low or high acidity levels simply based on the characteristic of the bean itself. For example, green coffee (or coffee beans that are in a pre-roasted state) is often described as having “light acidity” or “bright acidity,” referring to the astringency or pH of the coffee rather than the actual flavor.

Acidity levels in coffee are primarily impacted by three elements in distinct stages: roasting, grinding and brewing. During the roasting stage, the darker the beans, the lower the acidity level. Lighter roasts do tend to taste more acidic, but this can often be ameliorated through fine adjustments during the roasting stage.

The present invention provides for a general formula when it comes to the roasting stage, which is subdivided according to the length of time within the 3 stages of bean metamorphosis: drying time, browning stage and development stage. To achieve the desired “smoothness” of a particular coffee, the above-mentioned formula is utilized to create sweetness and reduce acidity levels of the finished coffee product. Specifically, during the roasting process, adjustments to heat and gas at different times, allow for maintenance of specific parameters for the beans during the preferred embodiment through the roasting stage. Additional factors are also preferentially adjusted, including room temperature, humidity and cleanliness of equipment.

The grinding stage is vital to creating the preferred embodiment of the present invention. Specifically, the finer ground coffee results in a longer extraction time, which results in a more acidic coffee. The coarser ground coffee results in water flowing through faster (during the brewing stage), yielding a reduced extraction time, which smooths out flavor and results in a more watered-down taste to the final coffee product. The coffee brewed by the present invention preferably has a grinding stage that falls somewhere between the two ends of the spectrum described above.

Finally, the brewing stage is fundamental to the present invention. The longer a coffee is brewed, the less acidic the coffee becomes. For example, the standard, least acidic coffee one could consume is a 24-hour cold brewed coffee. Important factors that are considered within the preferred embodiment of the present invention during the brewing stage include specific water quality and equipment cleanliness, which will make the coffee taste more or less acidic, depending on the desired parameters sought.

In a preferred embodiment, the pH range for the freeze-dried fruit component is from about 2.7 to about 7.8. Similarly, the preferred pH range for the freeze-dried vegetable component is from about 4.5 to about 6.0. Preferably, the pH range for the coffee varietal as used in the present invention is from about 4.5 to about 5.0.

In a most preferred embodiment and as shown in FIG. 1, the process of the present invention is comprised of the following steps:
1. Fruits and vegetables selected for the composition are freeze-dried and then ground to a fine powder
2. A variety of coffee with an optimal pH is then selected and roasted according to proprietary roast profiles. This serves to raise lower the pH and, as heat is further applied to the process, provides for oil to be extracted during the roasting process.
3. Following roasting of the coffee, the pH is measured.
4. If necessary, the pH is corrected to the desired value.
5. The coffee is ground, brewed to concentrate and the pH is measured. In the alternative, the coffee is ground and the pH is measured without brewing.
6. The ground and/or brewed coffee is freeze-dried.
7. At this step, the freeze-dried fruit and vegetable powder is added to the freeze-dried coffee powder.
8. The pH of the mixture is measured.
9. The combined freeze-dried powder is blended thoroughly in a mixer, after which the pH is measured.
10. Next a neutralizer is added to the mixture and the pH is measured.
11. Depending on the pH value, the pH is either corrected prior to packaging or additional neutralizer is added followed by another pH measurement.

Specific measures are taken when sourcing, roasting and brewing to reduce pH and acidic flavors in the coffee. In green bean form, coffees that are dry processed or a hybrid of wet and dry processed, are chosen for their less acidic properties, with less fermentation occurring with low exposure to water. Beans have been sourced from lower elevation regions which characteristically are known for less acidic coffees that are mellow and smooth in flavor.

Roasting techniques are implemented to decrease acidic flavors. There are 3 phases or intervals of time over the course of the roast cycle called the modulation phases. The first phase, known as the drying phase, consists of green beans going into a roaster resulting in a sharp drop in temperature as the cool beans hit the hot drum. After a short time, the beans and the drum reach a “turning point” at which point the beans and the drum reach the same temperature. The next phase includes the Maillard phase that is a non-enzymatic reaction that occurs between amino acids and reducing sugars in the beans that causes the beans to “brown.” The length of the Maillard phase is crucial to achieving the desired flavor and roast profile. The third phase, also known as the development phase, is the phase in which the darkness of a roast is determined.

All steps in the roasting process are taken to affect the phases and impact acidity. Examples of such variables that affect the modulation phases are charging beans at a higher temperature to shorten drying phase, burning off moisture quickly by increasing gas to 80%-100% to promote high thermal energy into the roast, lengthening the Maillard phase to increase sweet flavors, and longer development time to further highlight smooth and sweet flavors. Roasting on the darker side further reduces acidity by neutralizing acidic flavors. Further variables affecting roast include humidity, temperature of the room, and temperature of green beans, moisture content of green beans and cleanliness of the roach machine.

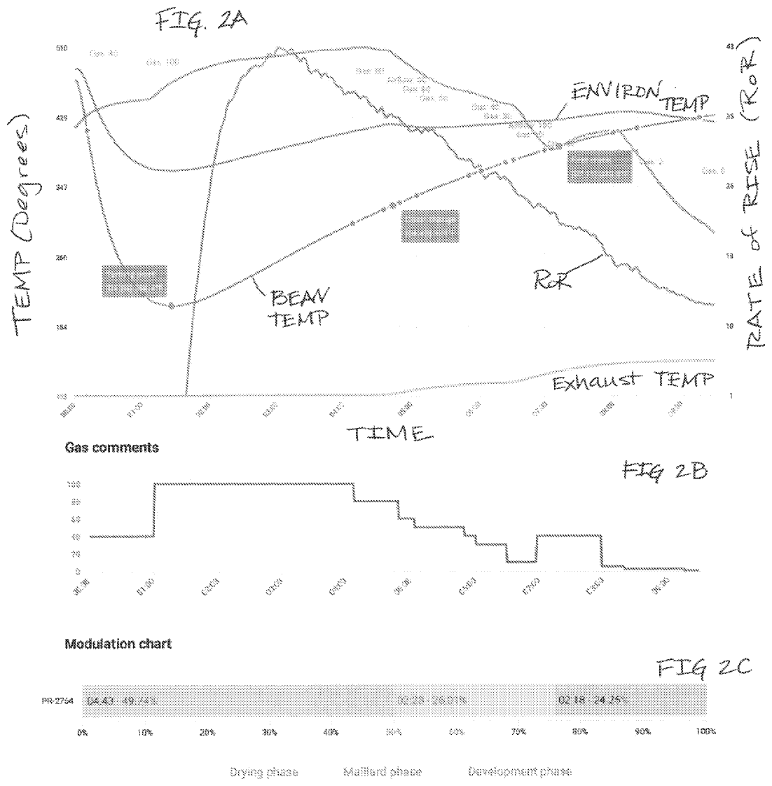

With reference to FIG. 2A-2C, shown is an example Roast Profile for a coffee processed according to the present invention. FIG. 2A demonstrates the relative changes in various temperature components during the roasting process. For example, following an initial drop at the beginning of the drying phase, the environmental temperature is stable over time. Environmental temperature is controlled by variables such as room temperature, gas and airflow. As expected bean temperature drops drastically after entering the drum however following the turning point the temperature steadily increases as the process continues. Bean temperature is controlled mainly by gas in the roaster. The Rate of Rise (RoR) curve displays the current increase in bean temperature over a time period call the time expression. FIG. 2A also shows how the changes in temperature correspond to the modulation phases. FIG. 2B shows the changes in gas over time during the roasting process. Lastly, FIG. 2C shows the breakdown of the roasting profile according to the length of time the process stays in each of the modulation phases.

The following tables show the best ranges for roasting based on the pH of the coffee, including Table 1 that shows the low acidic green coffee and Table 2 that exemplified the high acidic green coffee:

TABLE 1
Low Acidic Green Coffee (pH 5.1-6)

| Higher Charge Temp | 450-480 degrees |
|---|---|
| Drying Phase | 45%-50% |
| Maillard Phase | 25%-30% |
| Development Phase | 10%-20% |
| Drop Temp | 415-430 |

TABLE 2
High acid Green Coffee (pH 4.5-5)

| Higher Charge Temp | 450-480 degrees |
|---|---|
| Drying Phase | 45%-50% |
| Maillard Phase | 25%-40% |
| Development Phase | 18%-24% |
| Drop Temp | 420-430 |

The modulation chart includes ranges, exact percentages are determined and adjusted based on the pH of each recipe and combination of ingredients selected.

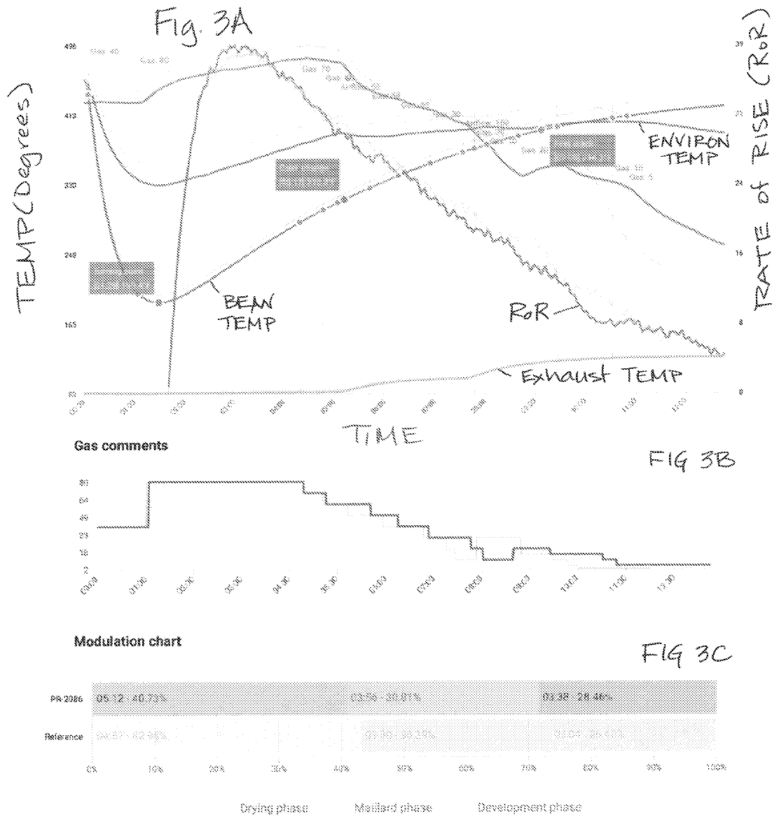

With reference to FIG. 3A-3C, shown is an example of a Roast Profile for a coffee processed according to the present invention wherein the variables in the roasting process were altered to adjust the modulation phases. FIG. 3A demonstrates the relative changes in various temperature components during the roasting process as compared to the values of the optimum roasting profile shown in FIG. 2A. For example, following an initial drop at the beginning of the drying phase, the environmental temperature is stable over time. Environmental temperature is controlled by variables such as room temperature, gas and airflow. As expected bean temperature drops drastically after entering the drum however following the turning point the temperature steadily increases as the process continues and despite the turning point occurring at 190.4 degrees as compared to the turning point occurring at 208.4 degrees in FIG. 2A, the first cracking of the beans in each example occurred within 1 degree of each other. The Rate of Rise (RoR) curve displays the current increase in bean temperature over a time period called the time expression. FIG. 2A shows how the changes in temperature correspond to the modulation phases while FIG. 3A demonstrates how the roasting profile is affected by just the smallest change in any one of the temperature variables. Lastly, FIG. 3C shows how the small changes in the temperature variables further alter the length of each of the modulation phases as compared to the modulation phases of the reference profile of FIG. 2C.

Water temperature also plays a key role in acidity. Higher water temperature extracts more acids, whereas a lower temperature extracts less, explaining why the chosen method of cold brew is less acidic than other brewing methods. The use of room temperature water helps limit acid extraction by slowing down oxidation and degradation of coffee molecules. At this stage, a specific cold brew concentrate of coffee is formed and is then freeze-dried to create an instant coffee set at the desired pH value.

Factoring in the specific acidity of the coffee component, the ingredients are mixed in the presence of a neutralizer component to maintain taste while raising the pH to a most desired level. Preferably, the neutralizer includes, but is not limited to, least one of malt, Dutch cocoa, sodium bicarbonate, oat milk powder and medium chain triglyceride (MCT) oil. Malt creates a basic effect to raise the pH. During the germination process of malt, there is an optimal level of germination that has the most idea neutralizing effect. Dutch cocoa has a similar effect, as most chocolate is acidic while Dutch cocoa has a more basic pH profile. Sodium bicarbonate neutralizes the composition in a similar manner as baking soda. Oat milk powder is very basic and serves to neutralize the composition and acidity profiles in a similar manner as described above.

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features. As used in this specification and in the appended claims, the singular forms include the plural forms. For example, the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

1. A dry mix composition comprising:
roasted coffee beans, wherein the beans are prepared as ground or freeze-dried;
at least one freeze-dried fruit component;
at least one freeze-dried vegetable component; and
an effective amount of at least one neutralizer.

2. The dry mix composition of claim 1, wherein the composition further comprises a milk component.

3. The dry mix composition of claim 1, wherein the beans are prepared as ground.

4. The dry mix composition of claim 1, wherein the beans are prepared as freeze-dried.

5. The dry mix composition of claim 1, wherein the at least one neutralizer is selected from the group consisting of malt barley, malted milk, sodium bicarbonate, oat milk powder, coconut milk powder, Dutch process cocoa and medium chain triglyceride (MCT) oil.

6. The dry mix composition of claim 1, wherein the at least one freeze-dried fruit component has a pH from about 2.7 to 7.8.

7. The dry mix composition of claim 1, wherein the at least one freeze-dried vegetable component has a pH from about 4.5 to 6.0.

8. The dry mix composition of claim 1, wherein the roasted beans are prepared at a pH from 4.5 to 5.0.

9. A method of formulating a freeze-dried coffee and fruit composition, comprising:
(a) providing a plurality of fruits and vegetables;
(b) freeze-drying the plurality of fruits and vegetables;
(c) grinding the freeze-dried product of (b) into a fine powder;
(d) providing coffee beans selected based on a desired pH;
(e) roasting the coffee beans to the desired pH;
(f) grinding the roasted coffee beans;
(g) freeze-drying the ground, roasted coffee beans;
(h) combining the freeze-dried coffee beans together with the freeze-dried powder of the fruits and vegetables by blending them both in a mixer to form a blended formulation;
(i) measuring the pH of the blended formulation; and
(j) adding a neutralizer to the blended formulation in order to maintain the desired pH.

10. The method of claim 9, wherein the method further comprises:
(k) adding a milk component.

11. The method of claim 9, wherein the neutralizer is selected from the group consisting of malt barley, malted milk, sodium bicarbonate, oat milk powder, coconut milk powder, Dutch process cocoa and medium chain triglyceride (MCT) oil.

12. The method of claim 9, wherein the pH is measured at least three times throughout the method.

13. A method of brewing coffee with a dry mix composition comprising a least one member selected from the group consisting of a freeze-dried fruit component and a freeze-dried vegetable component, the method comprising:
(a) selecting initial ingredients based on optimal pH;
(b) roasting an amount of coffee beans to the optimal pH;
(c) grinding the amount of coffee beans to the optimal pH;
(d) brewing an amount of coffee from the amount of coffee beans to create a brewed coffee;
(e) mixing the dry mix composition together with the brewed coffee; and
(f) adding at least one neutralizer component.

14. The method of claim 13, wherein the at least one member is a freeze-dried fruit component.

15. The methods of claim 13, wherein the at least one member is a freeze-dried vegetable component.

16. The method of claim 13, wherein the neutralizer is selected from the group consisting of malt barley, malted milk, sodium bicarbonate, oat milk powder, coconut milk powder, Dutch process cocoa and medium chain triglyceride (MCT) oil.
